(19) United States
(12) Patent Application Publication
(10) Pub. No.: US 2015/0307820 A1
(43) Pub. Date: Oct. 29, 2015

(54) APPARATUS AND METHOD FOR MULTI-SITE SPONTANEOUSLY FERMENTED BEER PRODUCTION

(71) Applicant: James Priest, Philadelphia, PA (US)

(72) Inventor: James Priest, Philadelphia, PA (US)

(21) Appl. No.: 14/697,457

(22) Filed: Apr. 27, 2015

Related U.S. Application Data
(60) Provisional application No. 61/984,556, filed on Apr. 25, 2014.

(51) Int. Cl. C12C 11/00

(52) U.S. Cl. CPC C12C 11/003

(57) ABSTRACT

A device allowing for and encouraging the spontaneous fermentation of unchilled wort, and which acts as a system of conveyance from site of brewing to site of fermentation. A mobile trailer is equipped with two stacked coolships (large pans of stainless steel and/or copper) and louvered windows in the upper walls of the trailer. Hot wort is pumped into upper coolship where it cools overnight before being drained into the lower coolship and capped for transport to fermentation site.

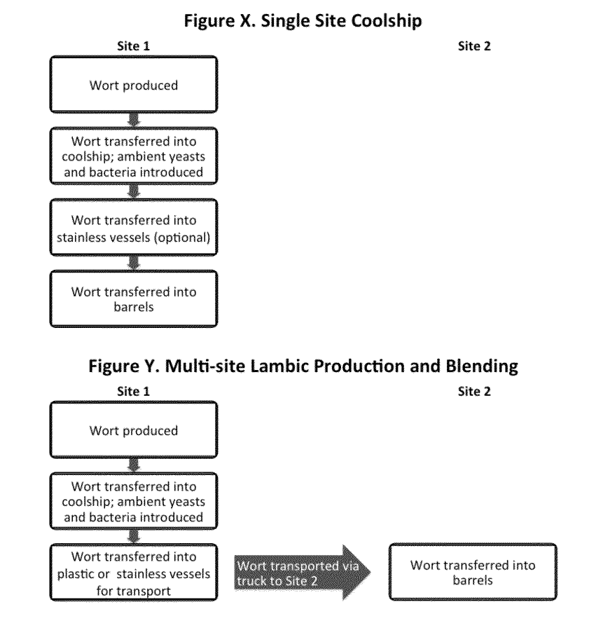

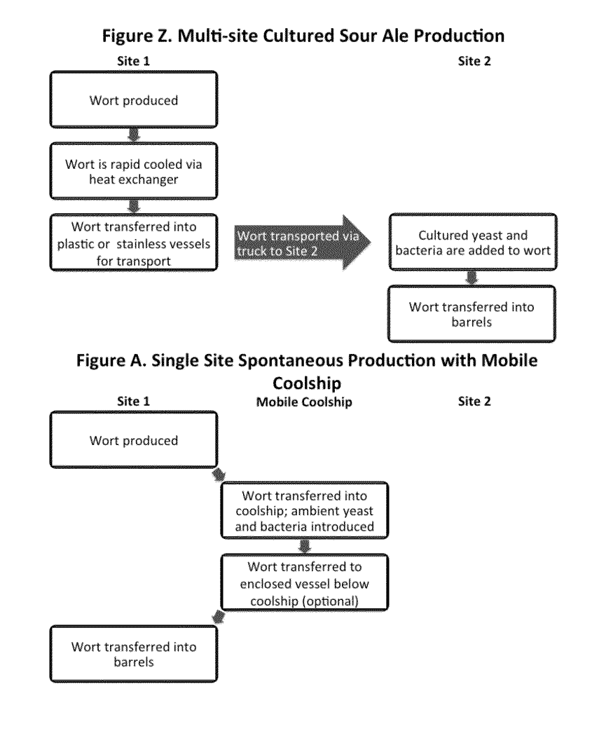

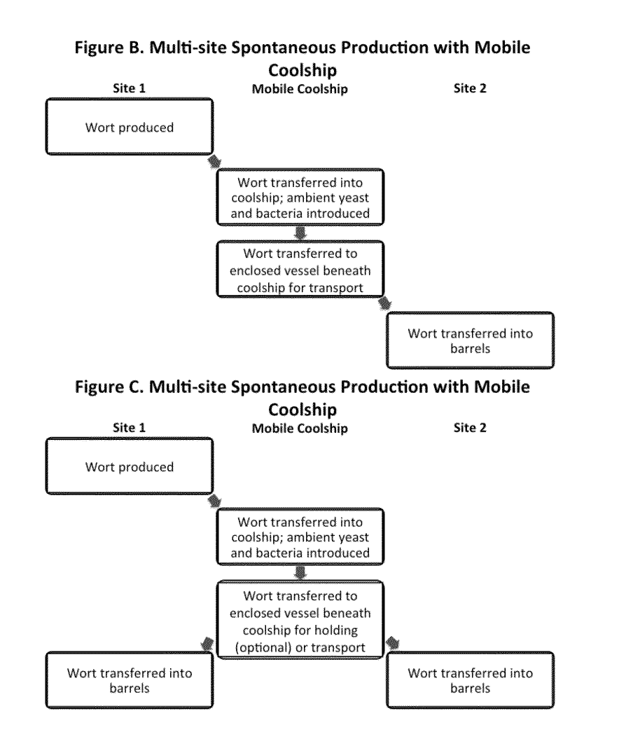

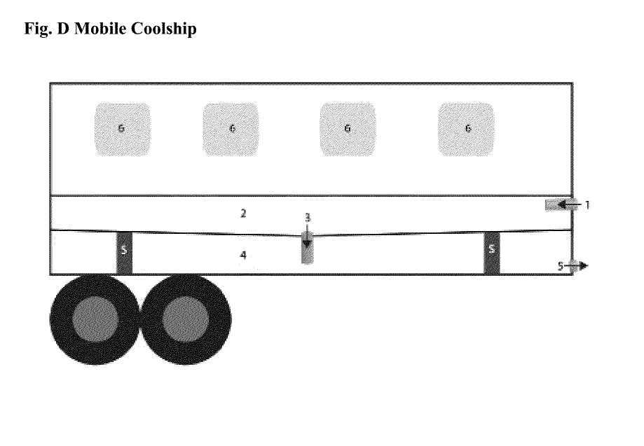

### FIELD

The present invention relates to the production of commercial multi-barrel production of spontaneously fermented beer, particularly to introduce the possibility of discrete sites of fermentation and brewing, in which each are specialized entities, or to minimize equipment costs by multiple breweries or production sites operating with the same mobile piece of equipment.

### BACKGROUND

The origin of beer production begins roughly concurrently with the origin of human civilization, in which soaked grains leached sugars into the surrounding liquid, forming a basic “wort”—the sweet, unfermented precursor to beer. Exposed to the open air, wild airborne yeasts and fermentative bacteria settled on the wort, which began the fermentation process: the conversion of sugars into alcohol.

The brewing process has developed considerably in sophistication since then. Modern conventional brewing implements highly specialized equipment throughout the brewing and fermentation process to exact a maximum of control over the product. Malted and/or unmalted grains, including but not limited to barley, wheat, rye, and oats are milled, which crushes the grains prior to brewing. Water, typically of an elevated temperature, is added to the grains or grist in a mash tun, and the water becomes wort as the steeped mixed grains lend a complex sugar solute.

The ensuing liquid wort is transferred from the mash tun to a brew kettle, where the wort receives hop additions and is boiled according to specification. At the end of this process, the hot hopped wort is rapidly chilled and transferred to a fermentation vessel. In the fermentation vessel, yeast is added to the wort and the fermentation process begins.

The yeast used is typically a strain of saccharomyces cerevisiae, or brewer's yeast, selected based on: flavor/aroma profile, environmental concerns (temperature at which the yeast thrives), and efficiency of propagation and fermentation. The basic function of the yeast, however, is to convert sugars to alcohol, with a byproduct of CO₂. With malt beverages, fermentation is the conversion of wort into beer.

There exists a brewing method utilizing only airborne or ambient yeasts, culturally and historically maintained by brewers in Belgium, particularly in the Senne Valley region near Brussels. These beers are known as lambics, and their production differs considerably from modern conventional brewing.

Lambic is chiefly characterized by its method of spontaneous fermentation, but there are many other defining characteristics of the brewing process and product. It is typically brewed with two grains: malted pilsner barley and unmalted wheat, representing around 65% and 35% of the total grist, respectively. These grains are milled and are brewed, as described above, traditionally utilizing a type of decoction mash known as a turbid mash. The hallmark of the turbid mash is the removal of liquid portions of the mash, boiling separately, adding fresh boiling water to the mash, and repeating this process before boiling the turbid mashed wort to the desired gravity. During the boiling, aged hops are added as a preservative and to impart light bitterness without contributing to the flavor or aroma of the finished beer. This turbid mash method is used to produce a wort which contains a maximum of dextrins, starches, and amino acids, which are favorable nutrients for some of the yeasts involved in the long fermentation.

This finished wort is transferred to a coolship located in the brewery. The wort cools there gradually overnight owing to its high surface area to volume ratio in conjunction with louvered windows, which open to let the cold night air cool the wort and introduce wild ambient airborne yeasts and bacteria. These yeasts and bacteria propagate in the nutrient-rich wort over time. Once cooled to ˜65° F. this spontaneously inoculated wort is pumped to wooden vessels for an extended fermentation in which the yeasts and bacteria undergo ecological succession whereby they gradually consume all fermentable material. The liquid entering the barrels is nutrient-rich, barely-hopped wort; the liquid which leaves the barrels months or years later is acidified beer containing alcohol.

Having thus established the process of product for lambic, it is important to note the intricacies and derivations of this general method. Because fermentation space is the limiting factor in a lambic producer's production volume, the brewing equipment and coolship are only in use a handful of days out of the year. From this inherent limitation arose the specialized lambic blender: a person or persons whose operation consists of purchasing lambic wort or young lambic from the brewers, and overseeing the aging, blending, and bottling processes at the blender facility. Fig. Y outlines the steps in this method of lambic production, in contrast to the basic single site proprietary coolship brewing/blending method described above, and outlined in Fig. X.

In America, the most prevalent descendant of the Belgian lambic is the American Wild Ale (AWA), which refers here to any beer produced with any introduction of cultured species or strains of the wild yeast brettanomyces, or fermentative bacteria, including but not limited to lactobacilli, pediococci, or acetobacteria.

In contrast to the American Wild Ale, the American Coolship Ale (ACA) derives its fermentative organisms spontaneously, without direct pitching of yeast or bacterial cultures post-wort production. In this way, its process more closely resembles Belgian lambic than any other given American Wild Ale.

Because there are no dedicated ACA brewers, and very few such producers, each producing on a small scale, the opportunity for a specialized lambic or ACA blender in America is not currently supportable. At least one blender of AWA in America currently exists, but again, without ACA capability, and requiring maintenance and propagation or purchase of wild yeasts to provide fermentative organisms for their wort which is to later become an AWA. This method is outlined in Fig. Z.

Breweries which brew both “clean” beers (those which contain no marked quantity of wild yeasts or bacteria) and “wild” beers (those which do contain a flavor-and aroma- contributing quantity of wild yeasts or bacteria) run the risk of infection to their clean beers. Many breweries working with both types of beers purchase and utilize completely separate equipment to reduce the risk of contamination to their clean beers.

It is advantageous to have an apparatus and corresponding process to produce spontaneously fermented beer, which utilizes multiple sites by way of a mobile coolship which first inoculates turbid-mashed wort or other desirable wort of a given specification with wild airborne yeasts and bacteria, and then transports the wort to a discrete fermentation site.

Owing to the general dearth of coolships in America, in a market which has been found to consume increasing volumes of lambic and ACA, it is advantageous to have an apparatus and corresponding process to allow breweries which wish to produce lambic or ACA to share between them a single coolship, as—owing to the limiting factor of fermentation space mentioned above—the coolship may seldom be used by a single brewery, making it economically advantageous to share one such apparatus between them, or to rent from one brewery or a third party, by means of a mobile coolship.

### SUMMARY

The present invention facilitates new production methods of spontaneously fermented beer. Utilizing one novel piece of equipment, the mobile coolship, three previously unavailable processes of sour ale development are made possible. A single site, comprising both brewing and fermentation operations could enter into an alternating proprietorship with one or more other breweries or a third party entity which makes the mobile coolship available to brewery clients.

It is an object and advantage of the present invention to provide an apparatus and process for the commercial production of spontaneously fermented ale at a favorable cost of production.

It is another object and advantage of the present invention to enable a blender of spontaneously fermented beer to exist fiscally independent of a brewing operation, by specializing in the equipment needed in each discrete site, thereby avoiding incurring full infrastructure costs associated with beer production.

It is another object and advantage of the present invention to enable a brewer and blender to split a batch of spontaneously inoculated wort between the two sites, with each providing the necessary equipment and service in the process.

It is another object and advantage of the present invention to enable a discrete fermentation company or blender to collect wort from a variety of breweries, providing a choice, likely lowering wort costs, and freeing wort availability from the schedule of a single brewhouse.

It is another object and advantage of the present invention to increase the overall production capacity of spontaneously fermented ales in regions that do not yet have the equipment infrastructure to support commercial production quantities of spontaneously fermented ales.

It is another object and advantage of the present invention to bring the coolship into open air contact in a variety of environs to facilitate the presence of diverse fermentative yeasts.

It is another object and advantage of the present invention to enable a third party business to own and operate one or more of the given apparatus, and to schedule and rent out the equipment to brewery facility clients.

It is another object and advantage of the present invention that a brewery or brewpub chain own one such mobile coolship, providing an economical mode of spontaneous fermentation while maintaining a consistent process across multiple sites.

It is another object and advantage of the present invention to provide the convenience and diversity of choice brought about by the mobility of spontaneously inoculated wort without being subject to various state and federal regulations and costs concerning the transport or shipment of alcoholic beverages, as it exists in a pre-alcoholic state during transport.

It is another object and advantage of the present invention that an existing operation of multi-site cultured sour ale production can easily employ spontaneous fermentation without any lapse between brewing and transference to the coolship.

It is another object and advantage of the present invention to lessen the risk of contamination to “clean” or non-wild beer from wild beer in facilities that produce both of the foregoing types of beer.

It is another object and advantage of the present invention to provide equipment to produce spontaneously fermented ale in a facility with space limitations that preclude the on-site existence of a coolship of desirable size.

The foregoing objects and advantages are provided by an apparatus and method which create a new infrastructure for producing spontaneously fermented beers, where a like or similarly-scaled infrastructure is not present.

### BRIEF DESCRIPTION OF THE FIGURE

FIG. X outlines a basic single site proprietary coolship brewing/blending method.

FIG. Y outlines a multi-site lambic production and blending steps.

FIG. Z outlines a method for multi-site cultured sour ale production.

FIG. A outlines steps to a single site production with a coolship.

FIG. B outlines steps to a multi-site spontaneous production with mobile coolship.

FIG. C outlines steps to a multi-site spontaneous production with mobile coolship.

FIG. D depicts a mobile coolship.

### DETAILED DESCRIPTION

The applicant discloses a mobile coolship unit to facilitate spontaneous fermentation of malt beverages that promotes equipment efficiency and multi-site capabilities. In one preferred mode of implementation, the mobile unit first allows for spontaneous inoculation of wort to occur, then provides transport of wort to a discrete fermentation site for aging. The apparatus, including all associated equipment, and method comprise and accomplish every step of production involved in spontaneous inoculation, while providing transportability of the apparatus and the ensuing inoculated wort.

Spontaneously fermented lambic-style beer is brewed with a portion of wheat (˜35% of the total grist), brewed in an altered decoction style known as a turbid mash, which is boiled for an extended period of time, typically upwards of three hours, with the addition of aged hops. The ensuing wort is then pumped to the coolship where it cools gradually overnight owing to its high surface area to volume ratio and louvered windows, which open to let the cold night air cool the wort and introduce wild ambient airborne yeasts and bacteria which propagate in the nutrient-rich wort over time. Once cooled to ˜65° F. this spontaneously inoculated wort is soon pumped to wooden vessels for an extended fermentation in which the yeasts and bacteria gradually consume all fermentable material, producing an esterified, acidified, alcoholic malt beverage.

The apparatus as depicted in Fig. D is the site of spontaneous inoculation, the event of origin for production of spontaneously fermented beer. Herein is described the production method outlined in Fig. A of multi-site spontaneous production with mobile coolship. Wort produced to specification is transferred to the coolship via hose connection to a port of entry 1, with the transferring wort filling the coolship 2. The volume of added wort fills the coolship, where drain 3 is stopped to prevent premature drainage into enclosure vessel 4. At a determined time, for a determined duration, the windows 6 are opened to facilitate air movement. Once the wort has been transferred to the coolship 2, hose may be removed from outside connection port 1.

At this time, the wort in coolship 2 begins a natural heat exchange process between the cooler ambient air entering through windows 6 and the heat of the wort which enters the coolship 2 at elevated (160° F.) to near-boiling temperatures (200° F.). The temperature of the wort in coolship 2 lowers gradually during this process, which takes place over hours, typically an overnight period. During this period, the wort in coolship 2 is exposed to ambient bacteria and yeast, which begin to propagate in the nutrient-rich wort. Spontaneous inoculation describes this process, just as spontaneous fermentation describes the long-term ecological succession of yeasts and bacteria that convert the sugars present in the wort into alcohol. Once the wort in coolship 2 is reduced to a more stable temperature and spontaneous inoculation has taken place, drain 3 is opened, and the wort from coolship 2 is transferred into enclosure vessel 4. Once the wort has completed draining to enclosure vessel 4, drain 3 may be stoppered completely or with an airlock if there is any likelihood of substantial early fermentation in transport.

With the wort spontaneously inoculated and chilled and secured in enclosure vessel 4, the wort is ready for transport. As shown in Fig. A, this means transporting the mobile coolship (Fig. D) to a discrete fermentation site, or Site 2, where the transfer of wort from enclosure vessel 4 to Site 2 fermentation vessel takes place via hose connection at enclosure vessel drainage port 5. Once enclosure vessel 4 is emptied, the hose at port 5 may be disconnected and all parts 1-5 may be cleaned to specification. Methods utilizing this apparatus which deviate slightly from this method are outlined in Claims, and in Figs. B and C.

Support structures S are used to reduce stress to equipment when coolship 2 contains the weight of a full wort transfer or similar load-bearing weight impositions.

The present invention differs from several similar existent production models in myriad ways. In the single site coolship method (Fig. X), which is popular in Belgium and favored by existing American breweries with their own coolships, brewing, cooling and spontaneous inoculation via a fixed coolship, and fermentation in wooden barrels all take place in the same facility. In the present invention, multi-site production is enabled by the mobile coolship. The present invention can also be incorporated into the single-site coolship method, with the coolship's mobility providing advantages in facility space management, limiting potential unwanted cross-contamination with other beer styles, and allowing for shared usage or alternating proprietorship with other beer production facilities.

The present invention also differs from the existent model of multi-site lambic production and blending (Fig. Y), which is popular in Belgium, as it allows lambic brewers to produce and sell wort beyond their fermentation capacity, and allows blenders to ferment lambic wort, and blend and sell lambic beer without incurring costs associated with brewing equipment. The present invention differs from this method by merging the spontaneous inoculation in coolship and wort or young lambic transport into one apparatus. It also allows for shifting ownership of the coolship and inoculation process away from the brewer and toward a discrete site or third party.

The present invention also differs from the existent model of multi-site cultured sour ale production (Fig. Z) by providing a method for spontaneous fermentation. In the cultured sour ale production, there is no coolship, no facilitated spontaneous fermentation, and features a forced rapid chilling of wort via heat exchange.

The present invention is distinct from prior beer production methods, and specifically distinct from prior production methods of spontaneously fermented beers. The present invention having thus been described, other modifications, alterations, or substitutions may suggest themselves to those skilled in the art, all of which are within the spirit and scope of the present invention.

What is claimed is:

1. A method for producing commercial volumes of spontaneously fermented beer, comprising:
a. transferring an amount of hot wort to a coolship located on or within a vehicle;
b. allowing the hot wort to become cooled wort via surface area contact to air at a lower temperature than the hot wort; and
c. allowing ambient yeasts and bacteria to enter the cooled wort in the coolship.

2. The method of claim 1 further comprising producing the hot wort in a brew kettle at a first location.

3. The method of claim 1 further comprising transferring at least a portion the cooled wort in the coolship to a holding vessel beneath the coolship for transport.

4. The method of claim 1 further comprising transporting at least a portion of the cooled wort to one or more locations.

5. The method of claim 4 wherein the one or more locations are fermentation sites.

6. The method of claim 1 further comprising transferring at least a portion of the cooled wort to one or more fermentation vessels for extended fermentation into finished beer.

7. A method for producing commercial volumes of spontaneously fermented beer, comprising:
a. producing hot wort in a brew kettle at a first location;
b. transferring at least a portion of the hot wort to a coolship located on or within a vehicle;
c. allowing the hot wort to become cooled wort via surface area contact to air at a lower temperature than the hot wort;
d. allowing ambient yeasts and bacteria to enter the cooled wort in the coolship;
e. transferring an aliquot of the cooled wort back to a holding vessel or fermentation vessel located in the first location;
f. transferring at least a portion of the cooled wort in the coolship to a holding vessel beneath the coolship for transport;
g. transporting at least a portion of the cooled wort to one or more fermentation sites;
h. transferring at least a portion of the cooled wort to one or more fermentation vessels for extended fermentation into finished beer.

8. A method for producing commercial volumes of spontaneously fermented beer, comprising:
a. transferring hot wort to a coolship located on or within a vehicle;
b. allowing the hot wort to become cooled wort via surface area contact with air at a lower temperature than the hot wort;
c. allowing ambient yeasts and bacteria to enter the cooled wort in the coolship;
d. transferring an aliquot of the cooled wort back to a holding vessel or fermentation vessel located in a brewing site; and
e. transferring a remaining portion of the cooled wort in the coolship to a holding vessel, optionally of similar shape to the fermentation vessel, beneath the coolship for transport.

9. The method of claim 8 further comprising producing the hot wort in a brew kettle at a first location.

10. The method of claim 8 further comprising transporting at least a portion of the cooled wort to a fermentation site.

11. The method of claim 8 further comprising transferring at least a portion of the cooled wort to fermentation vessels for extended fermentation into finished beer.

12. The method of claim 11 wherein the fermentation vessels are wooden or stainless steel fermentation vessels.

13. A method for producing commercial volumes of spontaneously fermented beer, comprising:
a. producing hot wort in a brew kettle in a brewing site;
b. transferring the hot wort to a coolship located on or within a vehicle;
c. cooling the hot wort to form cooled wort;
d. allowing ambient yeasts and bacteria to enter the cooled wort in the coolship; and
e. transferring the cooled wort back to a holding vessel or fermentation vessel located in the brewing site.

14. The method of claim 12 further comprising transferring the cooled wort to wooden or stainless steel fermentation vessels for extended fermentation into finished beer.

15. A mobile commercial-scale beer cooling apparatus, comprising:
a. at least one vessel having a surface area greater than its depth and a sealable aperture located at a top portion of the said vessel;
b. one or more ducts or windows configured to allow open-air or spontaneous fermentation/inoculation of wort inside the vessel;
c. one or more ports configured for adding liquid to the vessel; and
d. one or more ports configured for draining liquid from the vessel.

16. The mobile commercial-scale beer cooling apparatus of claim 15 further comprising at least one enclosure vessel located below the at least one vessel having a surface area greater than its depth.

17. The mobile commercial-scale beer cooling apparatus of claim 16 wherein the at least one enclosure vessel is separated from the at least one vessel having a surface area greater than its depth by a stoppable drain.
